(19) United States
(12) Patent Application Publication
(10) Pub. No.: US 2013/0079538 A1
(43) Pub. Date: Mar. 28, 2013

(54) ALKOXYSILANE FUNCTIONALIZED ISOCYANATE BASED MATERIALS

(71) Applicants: Christopher Phanopoulos, Moorsel (BE); Steve John Diamanti, The Woodlands, TX (US); Tugba Vardareli, Evere (BE); Servaas Holvoet, Veltem-Beisem (BE)

(72) Inventors: Christopher Phanopoulos, Moorsel (BE); Steve John Diamanti, The Woodlands, TX (US); Tugba Vardareli, Evere (BE); Servaas Holvoet, Veltem-Beisem (BE)

(73) Assignee: Huntsman Internatioanl LLC, The Woodlands, TX (US)

(21) Appl. No.: 13/702,783

(22) PCT Filed: Jun. 17, 2011
(86) PCT No.: PCT/EP2011/060092

§ 371 Date: Dec. 7, 2012

(30) Foreign Application Priority Data
Jun. 21, 2010 (EP) 10166594.1

(51) Int. Cl. C07F 7/18

(52) U.S. Cl. CPC C07F 7/1892; C07F 7/1804
USPC 556/414

(57) ABSTRACT

Alkoxysilane functionalized isocyanate based materials of low viscosity prepared by reacting in any possible order of addition an organic polyisocyanate with an isocyanate-reactive compound and an amino-functional alkoxysilane of formula I

R-HN-R¹-Si-(OR²)₃₋ₓ(R³)ₓ (I)

wherein R represents a group with electron withdrawing properties, R¹ is a linear of branched alkylene or arylene group, R² and R³ are identical or different and each represent alkylene or arylene groups and x is 0, 1 or 2.

The present invention relates to alkoxysilane functionalized isocyanate based materials which have a low viscosity, to a process for their preparation and their use.

Alkoxysilane-terminated polyurethanes which crosslink by means of moisture (through silane polycondensation) are increasingly being used as elastomeric coating, sealing and adhesive compositions in construction and in the automotive industry.

Alkoxysilane-terminated polyurethanes are typically prepared by reacting an isocyanate containing polyurethane prepolymer with an amino-functional alkoxysilane (see, e.g., DE 102008038399; US 2003/232942; U.S. Pat. No. 6,492,482).

These products generally have a high viscosity, and as a consequence, are difficult to process. This high viscosity has been directly related to hydrogen bonding (due to the presence of urea and urethane groups). Solutions to reduce the viscosity have hence focused on decreasing/eliminating the urethane/urea content in these silane-terminated polyurethane structures.

One such way of reducing the hydrogen bond density, and thus the viscosity is disclosed in EP 0372561, in which very long chain polyether polyols are used. This method requires polyether polyols with a high functionality and a low level of unsaturation and polydispersity. This approach has a significant effect only in the case of very long chain prepolymers, designed for low-modulus binders, and even then it is only possible to reduce rather than eliminate hydrogen bond density.

Another way of reducing the density of the hydrogen bonds is by reacting an OH-functional prepolymer with an isocyanate-functional alkoxysilane, as disclosed in U.S. Pat. No. 4,345,053, yielding an urea-free structure. Disadvantages of using isocyanate-functional alkoxysilanes are that isocyanatosilanes have limited availability, are expensive and in addition, from a toxicological standpoint, these silanes are objectionable.

US 2007/0055010 teaches another possibility for reducing the urea/urethane density, that is by partial or complete allophanatization and/or biuretization of the urethane/urea groups with mono-isocyanates, which sterically hinders hydrogen bond formation. Such terminal biurets should be distinguished from branching and chain lengthening biurets. This method however requires an additional synthetic step after preparation of the silane-terminated polyurethane. In addition, monoisocyanates also have environmental, health and safety issues.

Other solutions to reduce the viscosity are the use of mixtures of silane-terminated polyurethane structures, as disclosed in U.S. Pat. No. 5,539,045, having a viscosity less than the average of the viscosities of the constituent silylated polyurethanes.

An alternative method to reduce viscosity has now been found.

It has now been found that the use of electron withdrawing groups on the N-substituent of the amino-functional alkoxysilane minimizes the undesired, chain lengthening biuret formation—undesired because it increases viscosity—yielding low viscosity silane terminated materials. This invention enables the preparation of biuret-free alkoxysilane functionalized isocyanate based materials.

According to the present invention alkoxysilane functionalized isocyanate based materials are prepared by reaction in any possible order of addition of polyisocyanates with isocyanate-reactive compounds and with amino-functional alkoxysilanes of formula I

R-HN-R¹-Si-(OR²)₃₋ₓ(R³)ₓ (I)

wherein R represents a group with electron withdrawing properties, R¹ is a linear or branched alkylene or arylene group, R² and R³ are identical or different and each represent alkylene or arylene groups and x is 0, 1 or 2.

The polyisocyanate can be pre-reacted with the isocyanate-reactive compound to form a so-called isocyanate functional prepolymer.

The reaction of said polyisocyanates and/or said isocyanate functionalised prepolymers with amino-functional alkoxysilanes of formula I yields substituted urea groups according to equation II.

[prepolymer]-NCO+R-HN-R¹-Si-(OR²)₃₋ₓ(R³)ₓ→[prepolymer]-NH-CO-N(R)-R¹-Si-(OR²)₃₋ₓ(R³)ₓ (II)

In the process according to the invention, the undesired secondary reactions on urea bonds which yield extra chain extension through biuret formation are effectively suppressed. Biuret groups can be formed by reaction of the alkoxysilane functionalized isocyanate and/or its prepolymer with polyisocyanate and/or isocyanate functionalised prepolymers according to equation III.

[prepolymer]-NH-CO-N(R)-R¹-Si-(OR²)₃₋ₓ(R³)ₓ+[prepolymer]-NCO→[prepolymer]-N(CO-NH-[prepolymer])-CO-N(R)-R¹-Si-(OR²)₃₋ₓ(R³)ₓ (III)

Selection of appropriate R groups such that they are electron withdrawing has been surprisingly found to suppress reaction III.

Preferably, gamma-phenylaminopropyltrimethoxysilane is used as amino-functional alkoxysilane, which fully suppresses biuret formation, yielding a material of substantially lower viscosity than similar material based on R groups that do not contain an electron withdrawing group.

Suitable organic polyisocyanates for use in the present invention may be aromatic, cycloaliphatic, heterocyclic, araliphatic or aliphatic organic polyisocyanates.

The organic polyisocyanate used in the present invention may comprise any number or mixture of any number of polyisocyanates, including but not limited to, toluene diisocyanates (TDI), diphenylmethane diisocyanate (MDI)—type isocyanates, and prepolymers of these isocyanates. Preferably the polyisocyanate may have at least two aromatic rings in its structure. Difunctional aromatic isocyanates are preferred.

The functionality of an organic polyisocyanate, as such or as polymeric or prepolymeric polyisocyanate, which refers to the average number of isocyanate groups per molecule, averaged over a statistically relevant number of molecules present in the organic polyisocyanate, should preferably be at least 2.

In case diphenylmethane diisocyanate (also known as methylene diphenyl diisocyanate, and referred to as MDI) is used to provide a biuret free material according to the present invention, the diphenylmethane diisocyanate (MDI) used in the present invention can be in the form of its 2,4′-, 2,2′- and 4,4′-isomers and mixtures thereof, or in the form of mixtures of diphenylmethane diisocyanates (MDI) and oligomers thereof known in the art as “crude” or polymeric MDI (polymethylene polyphenylene polyisocyanates) having an isocyanate functionality of greater than 2, or any of their derivatives having a urethane, isocyanurate, allophonate, biuret, uretonimine, uretdione and/or iminooxadiazinedione groups and mixtures of the same.

Examples of other suitable organic polyisocyanates are tolylene diisocyanate (also known as toluene diisocyanate, and referred to as TDI), such as 2,4-TDI and 2,6-TDI in any suitable isomer mixture, hexamethylene diisocyanate (HMDI or HDI), isophorone diisocyanate (IPDI), butylene diisocyanate, trimethylhexamethylene diisocyanate, di(isocyanatocyclohexyl)methane, e.g. 4,4′- diisocyanatodicyclohexylmethane (H12MDI), isocyanatomethyl-1,8-octane diisocyanate and tetramethylxylene diisocyanate (TMXDI), 1,5-naphtalenediisocyanate (NDI), p-phenylenediisocyanate (PPDI), 1,4-cyclohexanediisocyanate (CDI), tolidine diisocyanate (TODI), any suitable mixture of these organic polyisocyanates, and any suitable mixture of one or more of these organic polyisocyanates with MDI in the form of its 2,4′-, 2,2′- and 4,4′-isomers and mixtures thereof or mixtures of diphenylmethane diisocyanates (MDI) and oligomers thereof.

According to an embodiment of the invention prepolymeric organic polyisocyanates are used in the present invention, such as quasi-prepolymers, semi-prepolymers or full prepolymers, which may be obtained by reacting organic polyisocyanates as set out above, and preferably MDI-based organic polyisocyanates, with any compound containing isocyanate-reactive hydrogen atoms in selected ratios.

Examples of compounds containing isocyanate-reactive hydrogen atoms suitable for use in the present invention include alcohols, glycols or even relatively high molecular weight polyether polyols and polyester polyols, mercaptans, carboxylic acids such as polybasic acids, amines, urea and amides.

Particularly suitable prepolymeric polyisocyanates are reaction products of polyisocyanates with monohydric or polyhydric alcohols.

Given as examples of the polyether polyols are polyethylene glycol, polypropylene glycol, polypropylene glycol-ethylene glycol copolymer, polytetramethylene glycol, polyhexamethylene glycol, polyheptamethylene glycol, polydecamethylene glycol, and polyether polyols obtained by ring-opening copolymerisation of alkylene oxides, such as ethylene oxide and/or propylene oxide, with isocyanate-reactive initiators of functionality 2 to 8. The functionality of the isocyanate-reactive initiators is to be understood as the number of isocyanate-reactive hydrogen atoms per molecule initiator. Polyester diols obtained by reacting a polyhydric alcohol and a polybasic acid are given as examples of the polyester polyols. As examples of the polyhydric alcohol, ethylene glycol, polyethylene glycol, tetramethylene glycol, polytetramethylene glycol, 1,6-hexanediol, 3-methyl-1,5-pentanediol, 1,9-nonanediol, 2-methyl-1,8-octanediol, and the like can be given. As examples of the polybasic acid, phthalic acid, dimer acid, isophthalic acid, terephthalic acid, maleic acid, fumaric acid, adipic acid, sebacic acid, and the like can be given.

Polytetramethylene ether glycol is generally not used as isocyanate-reactive compound in the present invention.

According to a preferred embodiment of the present invention the functionality of the isocyanate-reactive compound is at least 2 and its molecular weight is at least 400.

The molecular weight of the compounds containing isocyanate-reactive hydrogen atoms is preferably from 400 to 20000, more preferably from 400 to 10000 and most preferably from 1000 to 6000.

Prepolymeric polyisocyanates for use in the present invention are made from reaction of polyisocyanates with isocyanate-reactive compounds, preferably polyether polyols, generally using a NCO/OH molar ratio of at least 2, preferably from 2 to 100, preferably from 2 to 20, more preferably from 2 to 5 and most preferably from 2 to 4.

Using ratios of NCO/OH within these ranges the prepolymeric polyisocyanates do not contain any residual free isocyanate monomer and chain extension is limited or even avoided.

Prepolymeric polyisocyanates for use in the present invention generally have isocyanate values from 0.5 wt % to 33 wt %, preferably from 0.5 wt % to 12 wt %, more preferably from 0.5 wt % to 6 wt % and most preferably from 1 wt % to 6 wt %.

The prepolymeric polyisocyanates for use in the present invention are made according to methods familiar to those skilled in the art.

A catalyst may or may not be added to the reaction mixture.

Silane-terminated polyurethanes of the present invention can be made in any possible way known in the art by reacting polyisocyanates with compounds containing isocyanate-reactive hydrogen atoms and amino-functional alkoxysilanes, in any possible order of addition, yielding a completely tipped polyisocyanate in the final reaction product.

Suitable amino-functional alkoxysilanes include any compound corresponding to the formula I above wherein R represents an organic group known to have electron withdrawing properties, for example, but not limited to aryl, vinyl or carbamate. Aryl groups could be any group obtained by removing a hydrogen atom from an aromatic compound, i.e. an arene having one or more unsaturated rings. Typical groups have an aromatic backbone of 6 (based on benzene) or 10 (based on naphtalene) carbon atoms. Examples of aryl groups are phenyl, napthyl, tolyl, styryl and mixtures thereof. Phenyl groups are preferred in some embodiments. Vinyl groups could be any unsaturated compound where the vinyl functionality is terminal into the carbon backbone attached to the silane amine. Examples are vinyl, 1-propene, 2-methylpropene, 1-butene and 2-methylbutene. Carbamate groups could be, but are not limited to, methyl carbamato, ethyl carbamato, and the like.

Preferably R¹, as defined in formula I, represents a linear or branched alkylene or arylene group containing preferably 1 to 12 carbon atoms. More preferably, R¹ represents a linear alkylene group containing 1 to 4 carbon atoms. In the most preferred embodiment, R¹ represents a linear alkylene group containing 1 carbon (methylene, named alpha) or 3 carbons (propylene, named gamma).

Preferably, R² and R³, as defined in formula I, represent identical or different alkylene or arylene groups preferably having 1 to 4 carbon atoms. More preferably, R² and R³ represent identical alkylene groups having 1 to 4 carbons. In the most preferred embodiment, R² and R³ represent identical alkylene groups containing 1 carbon (methyl) or 2 carbons (ethyl).

Preferably, x in formula I is 0 or 1, most preferably 0.

In a preferred embodiment of the invention, the amino-functional alkoxysilane is selected from the group consisting of gamma-N-phenylaminopropyltrimethoxysilane, alpha-N-phenylaminomethyltrimethoxysilane, gamma-N-phenylaminopropyldimethoxymethylsilane, alpha-N-phenylaminomethyldimethoxymethylsilane, gamma-N-phenylaminopropyltriethoxysilane, alpha-N-phenylaminomethyltriethoxysilane, gamma-N-phenylaminopropyldiethoxyethylsilane and alpha-N-phenylaminomethyldiethoxyethylsilane.

One possible way to make the silane-terminated polyurethanes of the present invention is by complete tipping of prepolymeric polyisocyanates with amino-functional alkoxysilanes.

The organic prepolymeric polyisocyanate and amino-functional alkoxysilane are reacted according to methods familiar to those skilled in the art, typically neat or in solution. The reaction temperature is generally from −b 50° C. to 200° C., preferably from 0° C. to 125° C., more preferably from 25° C. to 100° C. and most preferably from 25° C. to 85° C.

A catalyst may be added to the reaction mixture. Furthermore a water scavenger, for example an organofunctional alkoxysilane, preferably vinyltrimethoxysilane or vinyltriethoxysilane, may be added to the reaction mixture.

In the preferred embodiment, the organic prepolymeric polyisocyanate and amino-functional alkoxysilane are reacted using an amine/NCO molar ratio from 1 to 100, preferably from 1 to 20, more preferably from 1 to 5 and most preferably from 1 to 3.

The process of the invention may be carried out continuously in a static mixer, extruder or compounder, e.g., or batchwise in a stirred reactor. The process of the invention is preferably carried out in a stirred reactor.

The biuret content in the present silane-terminated polyurethane reaction product may be measured by ¹³C-NMR analysis and may be expressed as the ratio of the biuret carbonyl intensity versus the urea carbonyl intensity (from the reaction of the polyisocyanate and the aminosilane). According to the invention, the biuret-urea ratio is generally less than 0.5, preferably less than 0.3 and more preferably less than 0.2. In the most preferred embodiment, the biuret-urea ratio is zero (in case biurets cannot be detected) indicating a biuret-free material.

Using the method described in the present invention a significant viscosity reduction of the reaction product may be achieved compared to materials synthesized in exact same conditions but made with aminosilanes having non-electron withdrawing substituents; the viscosity reduction obtained is generally at least 5%, preferably at least 10%, more preferably at least 20% and most preferably at least 50%.

The alkoxysilane terminated polyurethanes according to the present invention generally have viscosities in the range from 1 to 500 Pa.s, preferably from 5 to 200 Pa.s and more preferably from 10 to 150 Pa.s at room temperature.

Using phenyl-type substituted secondary aminosilanes, biuret side reactions can be almost fully prevented thereby providing alkoxysilane terminated polyurethanes with the lowest possible viscosity. In addition these reaction products are less susceptible to adventitous cure due to moisture contamination, hence having a higher shelf life.

Also the low viscosity is obtained without admixing with other components such as other isocyanate functionalised prepolymers/oligomers (whether produced in situ by premixing polyols or by prepolymerising separately and then mixing), other silylated polymers or silicones of whatever molecular weight.

The reaction product is not a foamed material (blowing agents are not added) and is also not an aqueous emulsion.

The materials of the invention are highly suitable for producing polyurethane sealants, for example but not limited to, for application in the construction sector. Additionally, they are suitable for producing adhesives, primers and coatings.

To prepare such sealants or adhesives, these low biuret alkoxy terminated polyurethanes can be formulated with known additives such as plasticizers, fillers, pigments, dryers, light stabilizers, antioxidants, thixotropic agents, catalysts and adhesion promoters by known methods of production.

Having generally described this invention, a further understanding can be obtained by reference to certain specific examples which are provided herein for purposes of illustration only, and are not intended to be limiting.

### EXAMPLES

### Example 1—Preparation of a Biuret-Free Alkoxysilane-Terminated Polyurethane

Diphenylmethane diisocyanate (MDI) was weighted into a reaction flask under nitrogen atmosphere. Polypropyleneglycol of MW 2000 (PPG2000) (1.05 equivalent MDI per OH) was dried under vacuum at 105° C. and after cooling to 70° C., added to the MDI while blanketing with nitrogen and stirring at 150 rpm. The temperature was maintained at 80° C. until a constant isocyanate (NCO) content was reached. The NCO content was determined by titration according to DIN 53185 (NCOv 3.38 wt %). According to the NCO content, 1.05 equivalents of gamma-N-phenylaminopropyltrimethoxysilane (Gelest SIP6724.0) was added dropwise (8 w % silane/minute) at 70° C. in the second reaction stage. Stirring was continued (at 100 rpm) until NCO was not longer detected. The material was then filled into containers flushed with nitrogen.

### Example 2—Preparation of an Alkoxysilane-Terminated Polyurethane with Low Biuret Content

The same polyisocyanate prepolymer from Example 1 was endcapped with 1.05 equivalents of alpha-N-phenylaminomethyltrimethoxysilane (Wacker Geniosil XL973) applying the same reaction procedures.

### Example 3—Comparative Example

The same polyisocyanate prepolymer from Example 1 was endcapped with 1.05 equivalents of gamma-N-cyclohexylaminopropyltrimethoxysilane (Wacker Geniosil GF92) applying the same reaction procedures.

### Example 4—Comparative Example

The same polyisocyanate prepolymer from Example 1 was endcapped with 1.05 equivalents of gamma-N-methylaminopropyltrimethoxysilane (Gelest SIM6500.0) applying the same reaction procedures.

### Example 5—Preparation of a Biuret-Free Alkoxysilane-Terminated Polyurethane

Diphenylmethane diisocyanate (MDI) was weighted into a reaction flask under nitrogen atmosphere. Polypropyleneglycol PPG2000 (2.50 equivalents MDI per OH) was dried under vacuum at 105° C. and after cooling to 70° C., added to the MDI while blanketing with nitrogen and stirring at 150 rpm. The temperature was maintained at 80° C. until a constant isocyanate (NCO) content was reached. The NCO content was determined by titration according to DIN 53185 (NCOv 9.90 wt %). According to the NCO content, 1.05 equivalents of gamma-N-phenylaminopropyltrimethoxysilane (Gelest SIP6724.0) was added dropwise (8 w % silane/minute) at 70° C. in the second reaction stage. Stirring was continued (at 100 rpm) until NCO was not longer detected. The material was then filled into containers flushed with nitrogen.

### Example 6—Comparative Example

The same polyisocyanate prepolymer from Example 5 was endcapped with 1.05 equivalents of gamma-N-cyclohexylaminopropyltrimethoxysilane (Wacker Geniosil GF92) applying the same reaction procedures.

All alkoxysilane functionalized isocyanate based polymers synthesized in Examples 1 till 6 are summarized in the table below. Viscosity was measured using a Brookfield rheometer meter at a temperature of 25° C. The biuret-urea carbonyl ratio was calculated from ¹³C-NMR analysis in CDCl₃ with a Bruker 500 MHz spectrometer. The biuret-urea carbonyl ratio was obtained using the intensities of the biuret carbonyl signal at 155.14 ppm and the urea carbonyl signal at 155.10 ppm.

Results are presented in the table below.

| | NCO content | | | Biuret/urea |
|---|---|---|---|---|
| | prepolymer | Trimethoxysilane | Viscosity | carbonyl |
| Example | (wt %) | endcapper | (Pa s) | ratio |
| 1 | 3.38 | gamma-N- | 70 | NA* (~0) |
| | | phenylaminopropyl | | |
| 2 | 3.38 | alpha-N- | 90 | 0.15 |
| | | phenylaminomethyl | | |
| 3 | 3.38 | gamma-N- | 209 | 0.79 |
| | | cyclohexylaminopropyl | | |
| 4 | 3.38 | gamma-N- | 262 | 1.14 |
| | | methylaminopropyl | | |
| 5 | 9.90 | gamma-N- | 110 | NA* (~0) |
| | | phenylaminopropyl | | |
| 6 | 9.90 | gamma-N- | 640 | 2.64 |
| | | cyclohexylaminopropyl | | |

*non applicable: biuret signal intensity was below sensitivity NMR spectrometer

Using phenyl-type substituted secondary aminosilanes, biuret side reactions can be almost fully prevented in this way providing alkoxysilane terminated polyurethanes with the lowest possible viscosity.

1. A process for preparing alkoxysilane functionalized isocyanate based materials comprising the step of reacting in any possible order of addition an organic polyisocyanate with a compound containing isocyanate-reactive hydrogen atoms and with an amino-functional alkoxysilane of formula I
R-HN-R¹-Si-(OR²)₃₋ₓ(R³)ₓ (I)
wherein R represents a group with electron withdrawing properties, R¹ is a linear or branched alkylene or arylene group, R² and R³ are identical or different and each represent alkylene or arylene groups and x is 0, 1 or 2.

2. The process according to claim 1 wherein the organic polyisocyanate is pre-reacted with the compound containing isocyanate-reactive hydrogen atoms to form a so-called isocyanate functional prepolymer.

3. The process according to claim 1 wherein the compound containing isocyanate-reactive hydrogen atoms has a functionality of at least 2 and a molecular weight of at least 400.

4. The according to claim 1 wherein the polyisocyanate is reacted with the isocyanate-reactive compound in a molar ratio NCO/OH of at least 2.

5. The process according to claim 1 wherein the molar ratio amine/NCO is from 1 to 100.

6. The process according to claim 1 wherein said polyisocyanate is a difunctional aromatic isocyanate.

7. The process according to claim 1 wherein said polyisocyanate is based on diphenylmethane diisocyanate.

8. The process according to claim 1 wherein R represents an aryl, vinyl or carbamate group.

9. The process according to claim 8 wherein R is a phenyl group.

10. The process according to claim 1 wherein R¹ represents a linear alkylene group containing 1 to 4 carbon atoms.

11. The process according to claim 1 wherein both R² and R³ represent an alkylene group having 1 to 4 carbon atoms.

12. The process according to claim 1 wherein x is 0 or 1.

13. The process according to claim 1 wherein the amino-functional alkoxysilane is gamma-N-phenylaminopropyl trimethoxysilane.

14. An alkoxysilane functionalized isocyanate based material obtainable by the process of claim 1.

15. An alkoxysilane functionalized isocyanate based material according to claim 14 having a biuret-urea ratio of less than 0.5.

16. An alkoxysilane functionalized isocyanate based material according to claim 14 having a viscosity of at most 200 Pa.s.

17. An alkoxysilane functionalized isocyanate based material according to claims 14 wherein the alkoxysilane functionalized isocyanate based material comprises a sealant, an adhesive, a primer or a coating.

18. An alkoxysilane functionalized isocyanate based material according to claim 16, wherein the viscosity is at most 150 Pa.s at room temperature.
